(19) United States
(12) Patent Application Publication
(10) Pub. No.: US 2018/0309301 A1
(43) Pub. Date: Oct. 25, 2018

(54) SOLAR ARRAY COMMUNICATIONS

(71) Applicants: Fan Wang, San Marino, CA (US); Jing Wang, Palo Alto, CA (US)

(72) Inventors: Fan Wang, San Marino, CA (US); Jing Wang, Palo Alto, CA (US)

(21) Appl. No.: 15/494,284

(22) Filed: Apr. 21, 2017

(51) Int. Cl. H02J 3/40; H02S 40/36; H02S 40/32; H02S 50/10; H02J 3/38; H02J 3/14

(52) U.S. Cl. CPC H02J 3/40; H02S 40/36; H02J 3/14; H02S 50/10; H02J 3/383; H02S 40/32

(57) ABSTRACT

A solar panel array includes panel bridges associated with solar panels and a signal bridge associated with the converter for communicating with the panel bridges.

### BACKGROUND OF THE INVENTION

### Field of the Invention

The present invention relates to an article of manufacture for conducting electrical signals. In particular, a solar array communicates signals such as signals destined for or originating from a solar panel.

### Discussion of the Related Art

Solar panel arrays provide for generation and collection of electric power. Communication from the panels of information including current and voltage has been an afterthought. Communication to the panels is a facility that has received little if any attention.

### SUMMARY OF THE INVENTION

The present invention provides a means for communicating signals through a solar array. In an embodiment a solar panel array communications system comprising: a plurality of panels connected in a series circuit, the panels for supplying a converter; signal bridges including a resistor in parallel with a capacitor; panel bridges including a signal bridge in parallel with a diode; a signal bridge across the converter inputs and a first toroidal transformer for injecting a current into the signal bridge capacitor; and, for each of the panels a panel bridge across the panel outputs, a second toroidal transformer for sensing current passing through the panel bridge, and a switch activated by the second toroidal transformer; wherein the switch is for removing the panel from the circuit and a change in current injected by the first toroidal transformer is sensed by the second toroidal transformer to change the state of the switch.

In an embodiment the solar panel array communications system further comprises: a temperature transducer for measuring a temperature associated with one of the solar panels; the second toroidal transformer for injecting a current in the panel bridge lead that is related to the measured temperature; and, the first toroidal transformer for sensing the injected current. In an embodiment the solar panel array communications system further comprises: a current transducer for measuring a current associated with one of the solar panels; the second toroidal transformer for injecting a current in the panel bridge lead that is related to the measured current; and, the first toroidal transformer for sensing the injected current. In an embodiment the solar panel communications system further comprises: a voltage transducer for measuring a voltage associated with one of the solar panels; the second toroidal transformer for injecting a current in the panel bridge lead that is related to the measured voltage; and, the first toroidal transformer for sensing the injected current.

In an embodiment, a solar panel array communication system comprising: a plurality of panels connected in a series circuit, the panels for supplying a converter; signal bridges including a resistor in parallel with a capacitor; panel bridges including a diode in parallel with a signal bridge; for a first pair of panels, panel bridges across panel outputs and a first toroidal transformer for sensing current in a panel bridge lead; for each of the first pair of panels, switches for removing the panels from the circuit; for a second pair of panels, panel bridges across panel outputs and a second toroidal transformer for sensing current in a panel bridge lead; for each of the second pair of panels, switches for removing the panels from the circuit; and, a signal bridge across the converter inputs and a third toroidal transformer for injecting current into a signal bridge lead; wherein the state of the switches is changed when the current injected at the third toroidal transformer is changed.

In an embodiment, the solar panel array communication system further comprises: a temperature transducer for measuring a temperature associated with one of the solar panels; the second toroidal transformer for injecting a current in the panel bridge lead that is related to the measured temperature; and, the third toroidal transformer for sensing the injected current. In an embodiment, the solar panel communication system further comprises: a current transducer for measuring a current associated with one of the solar panels; the second toroidal transformer for injecting a current in the panel bridge lead that is related to the measured current; and, the third toroidal transformer for sensing the injected current. In an embodiment the solar panel communication system further comprises: a voltage transducer for measuring a voltage associated with one of the solar panels; the second toroidal transformer for injecting a current in the panel bridge lead that is related to the measured voltage; and, the third toroidal transformer for sensing the injected current.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows a system including an array of solar panels connected to a converter via bridges.

FIG. 2A-D show a converter and signal bridge with controller of the system of FIG. 1.

FIG. 3A-D show a panel bridge with controller and solar panel of the system of FIG. 1.

FIG. 4 shows operating modes of the system of FIG. 1.

FIG. 5 shows another embodiment of a system including an array of solar panels connected to a converter via bridges.

FIG. 6A-B show a panel bridge with controller connected to a plurality of solar panels of the system of FIG. 5.

FIG. 7A-B show alternative panel bridge with controller designs.

### DESCRIPTION OF THE PREFERRED EMBODIMENTS

The disclosure provided herein describes examples of some embodiments of the invention. The designs, figures, and descriptions are non-limiting examples of the embodiments they disclose. For example, other embodiments of the disclosed device and/or method may or may not include the features described herein. Moreover, disclosed advantages and benefits may apply to only certain embodiments of the invention and should not be used to limit the disclosed invention.

The present invention provides a means for communicating signals within a solar panel array. Embodiments of the invention utilize toroidal transformers in transceivers that inject signals into the solar panel array and that obtain signals from the solar panel array.

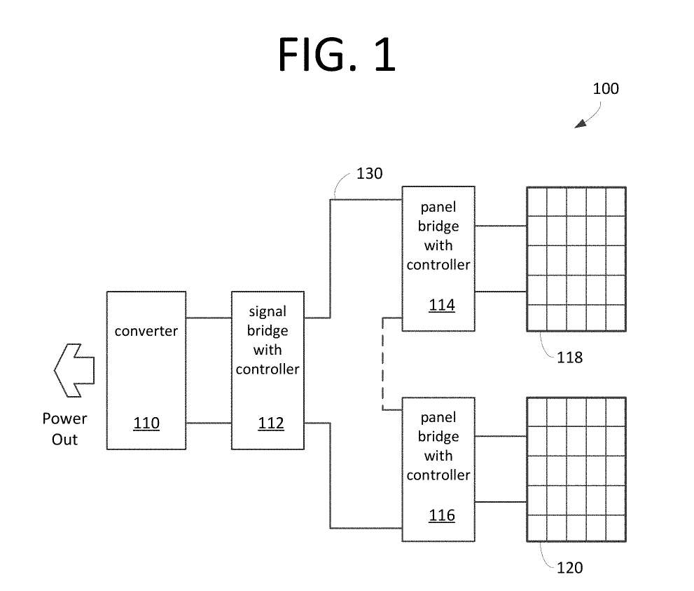

In FIG. 1, an array of solar panels connected to a converter is shown 100. The solar panels 118, 120 are photovoltaic panels and have a voltage output when in the presence of sunlight.

The solar panels 118, 120 are connected to a power converter 110. The converter may be a DC to AC converter or a DC to DC converter or some combination of the two. As shown, there is but one converter for a multiplicity of panels in this string converter system. Typically the converter is mounted remotely from the solar panel array.

The solar panels 118, 120 are connected to the converter 110 via bridges. Each of the panels is connected to a signal bridge with controller 112 by a panel bridge with controller 114, 116 and the panel bridges are interconnected. In turn, the signal bridge is connected to the converter 110.

As explained below, it is possible to pass a high frequency signal through the solar panel wiring. In particular, a signal may be passed from the signal bridge 112 to panel bridge 114 and 116 and from the panel bridge to the signal bridge over interconnecting wiring 130. As described, i) the converter to signal bridge interconnect, ii) the signal bridge to panel bridge interconnect, and iii) the solar panel to panel bridge interconnect do not preclude intervening devices.

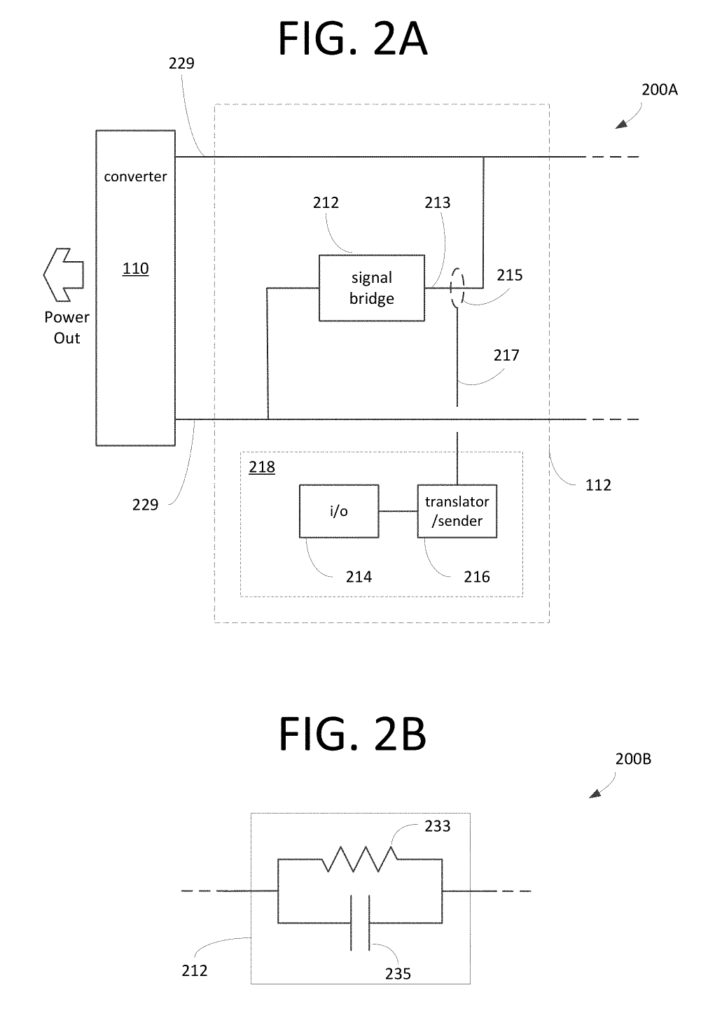

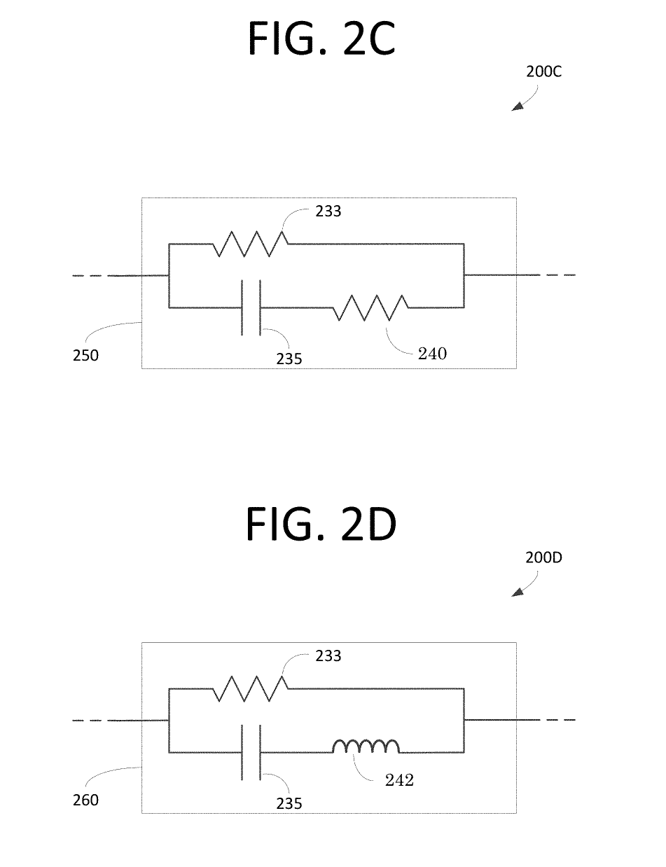

FIG. 2A shows the converter and a signal bridge with controller 200A. In the figure, a signal bridge 212 is across the inputs 229 of the converter 110. Coupled with a signal bridge lead 213 is a magnetic coupler such as a toroidal transformer 215.

Signals from the toroidal transformer 217 are passed with or exchanged with a controller 218. In the controller, a translator/sender 216 translates signals from or sends signals to the toroidal transformer. For example, signals obtained from the signal bridge are translated and sent to the input/output block 214. For example, signals sent to the solar panels 118, 120 may originate at the input/output block 214, be translated, and be passed through the wiring 130 to the panel bridge with controller 114, 116.

Signals are sent when the toroidal transformer 215 injects a current into the signal bridge. These signals may accomplish a number of functions including the function of removing one or more of the solar panels from the circuit. Signals received when the toroidal transformer 215 is excited by a current in the signal bridge provide information about the solar panel array including voltage, current, and temperature.

The signal bridge controller 218 or parts thereof may be implemented in or included in hardwired logic or in multipurpose logic such as an application specific integrated circuit (“ASIC”), a microcontroller, a computer processing unit (“CPU”), or a field programmable gate array (“FPGA”).

FIG. 2B shows a signal bridge 200B. As shown, the bridge includes a resistor 233 that is in parallel with a capacitor 235. The capacitor provides a communication path for high frequency signals, for example signals in the range of 50.0 to 200.0 kilohertz. The resistor is optional and may provide a means for draining the energy stored in the capacitor.

In an embodiment, values of the capacitor range from 2.0 to 20.0 microfarads. In an embodiment, values of the resistor range from 1.0 to 10.0 megaohms.

FIG. 2C shows a signal bridge 200C. As shown, the bridge includes a capacitor 235 in series with a resistor 240 (a first network) and the first network in parallel with a resistor 233. Values are similar to those above for the capacitor 235 and the resistor 233. The value of the second resistor 240 is small compared with the value of resistor 233. In an embodiment, the value of the second resistor is 1 to 10 ohms. The signal bridge 250 may be substituted for signal bridge 212. The signal bridge 250 may be substituted for the signal bridge 342.

FIG. 2D shows a signal bridge 200D. As shown, the bridge includes a capacitor 235 in series with an inductor 242 (a second network) and the second network in parallel with a resistor 233. Values are similar to those above for the capacitor 235 and the resistor 233. The value of the inductor 242 is small. In an embodiment, the value of the inductor is 1 to 1,000 nH. The signal bridge 260 may be substituted for the signal bridge 212. The signal bridge 260 may be substituted for the signal bridge 342.

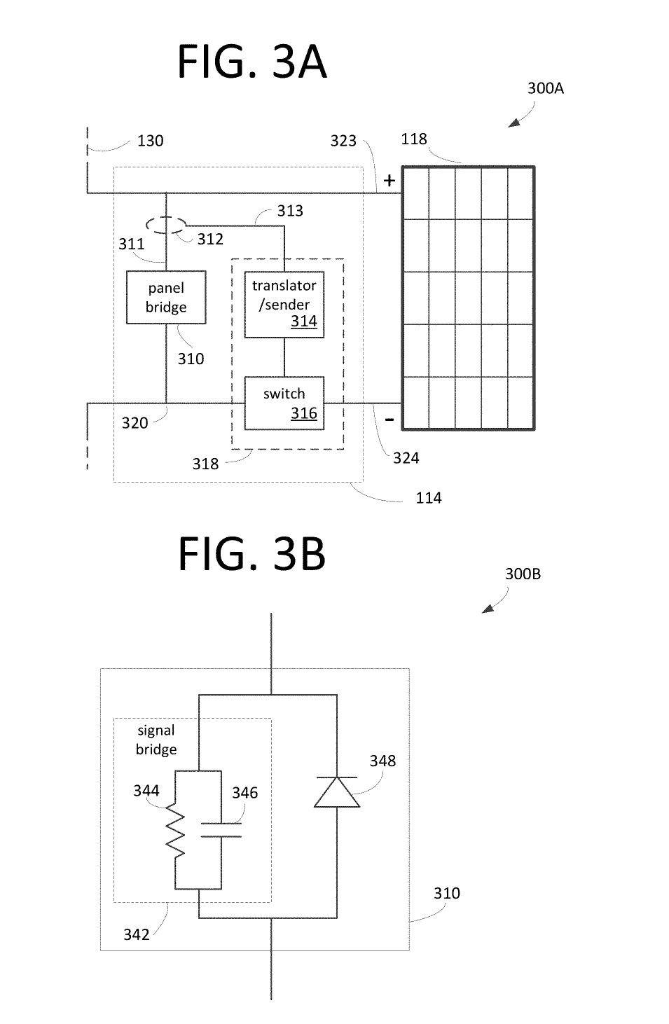

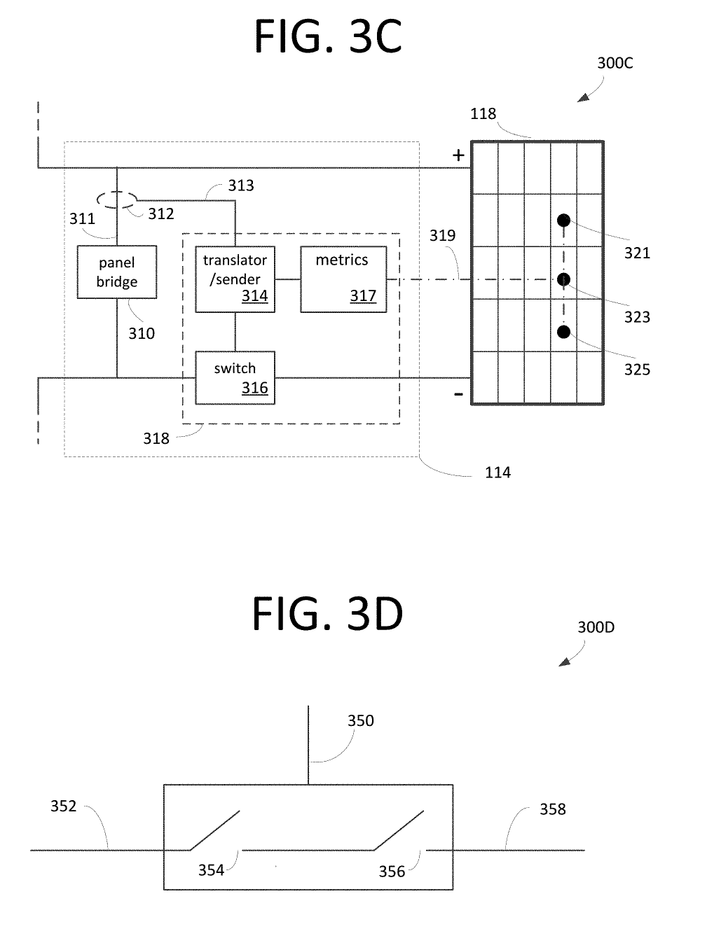

Typical of the panel bridge with controllers 114, 116 is FIG. 3A which shows a solar panel connected to a panel bridge with controller 300A.

As seen in FIG. 3A, the panel bridge with controller 114 is in the circuit with the solar panel 118. The panel bridge with controller 114 includes a panel bridge 310 which is connected across the outputs 323, 324 of the solar panel 118. Coupled with a panel bridge lead 311 is a magnetic coupler such as a toroidal transformer 312.

A disconnect device such as a switch or a plurality of switches 316 is in an output of the solar panel such as a negative output 324 of the solar panel 118. In an embodiment, the disconnect device or one of the switches is between the solar panel and the connection 320 with the panel bridge 310.

Signals arriving at the toroidal transformer 312 are passed to the controller 318. In the controller, a translator/sender 314 translates the signals and passes them on. Where the signals are passed to a switch 316, a change in the received toroidal signal may change the state of the switch. For example, the change may be a logic 0 or 1. For example, the change may be a string of logic such as a string of logic that forms a logical word or logical words.

Signals leaving the toroidal transformer 312 are passed from the translator/sender 314 in the controller 318 to the toroidal transformer 312. Injected into the panel lead 311 by the toroidal transformer 312, the signals are conducted by the wiring 130 to the signal bridge at the converter.

The translator/sender 314 or parts thereof may be implemented in or included in hardwired logic or in multipurpose logic such as an application specific integrated circuit (“ASIC”), a microcontroller, a computer processing unit (“CPU”), or a field programmable gate array (“FPGA”).

FIG. 3B shows the panel bridge 300B. The panel bridge 310 includes a signal bridge 342 in parallel with a diode 348. The signal bridge includes a capacitor 346 in parallel with a resistor 344.

In an embodiment, values of the capacitor 346 range from 2.0 to 20.0 microfarads. In an embodiment, values of the resistor 344 range from 1.0 to 10.0 megaohms. In an embodiment, the diode is an 80V, 15Amp, Schottky diode.

FIG. 3C shows a solar panel connected to a panel bridge in another configuration 300C. In this embodiment the controller 318 includes a metrics module such as a metric module 317 connected to the translator/sender 314 for exchanging signals with the translator/sender. The metrics may include measures associated with the solar panel or solar panel performance. Signals including signals from transducers may originate at the metrics module and signals including signals from transducers may be sent to the metrics module.

The metrics module 317 may be in the controller 318 and/or in the solar panel 118. The metrics module 317 may have electrical connections 319 to the panel or to sensors in the panel such as electrical connections to a temperature sensor 321, a current sensor 323, and a voltage sensor 325.

FIG. 3D shows a disconnect device 300D. The disconnect device may include one or more switches (two shown) and the switches may be ganged or not. In an embodiment, two switches 354, 356 are ganged such that an appropriate signal input to the switch 350 either opens both of the switches (352 is disconnected from 358 twice) or closes both of the switches (352 is connected to 358). As skilled artisans will appreciate, certifying bodies such as Underwriters Laboratories may require that solar panel disconnects be redundant.

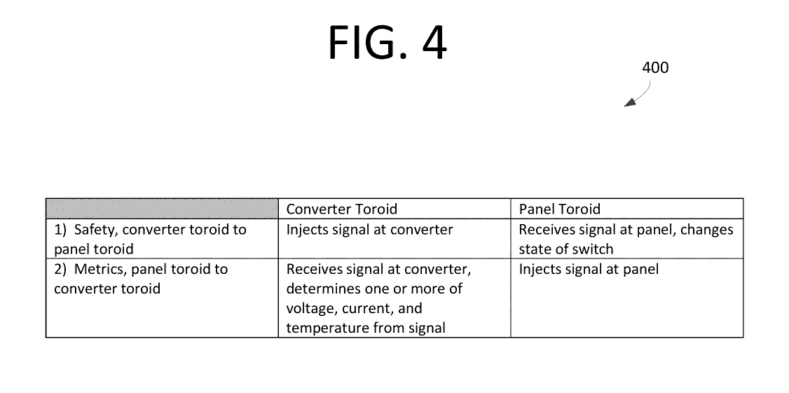

FIG. 4 shows communications via the toroidal transformers 400. In a first operating mode, safety signals are passed from the converter toroid 215 to the panel toroid 312. Here, the converter toroid 215 injects a signal at or near the converter 110 and the panel toroid 312 receives the signal at the panel 118 to change the state of the switch 316.

In a second operating mode, metrics are passed from the panel toroid 312 to the converter toroid 215. Here, the panel toroid 312 injects a signal at or near the panel 118 and the converter toroid 215 receives the signal at the converter 110 to convey information to the translator sender 216 and to the i/o 214. For example, where temperature information from the temperature sensor 321 is conveyed, the translator/sender may provide a translation of the signal and the i/o may utilize directly or indirectly the translated signal in managing the solar array.

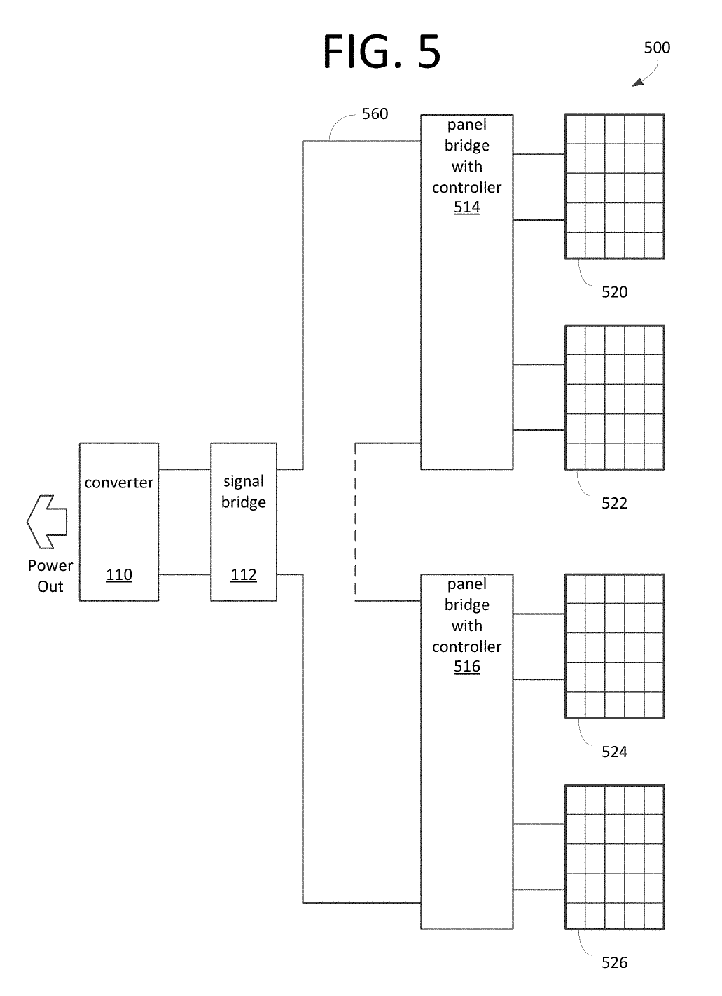

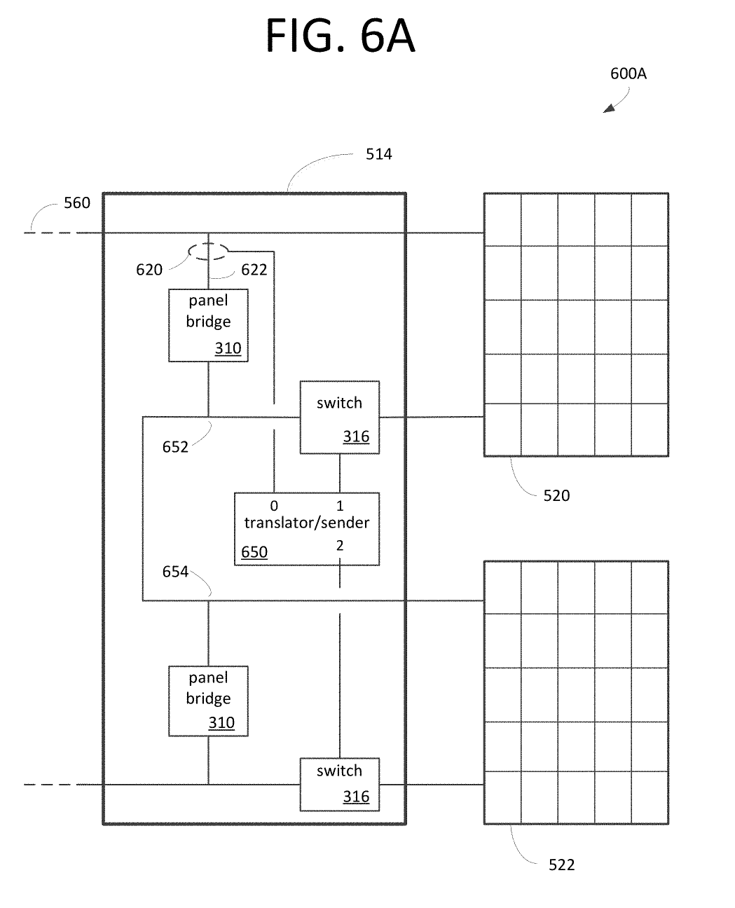

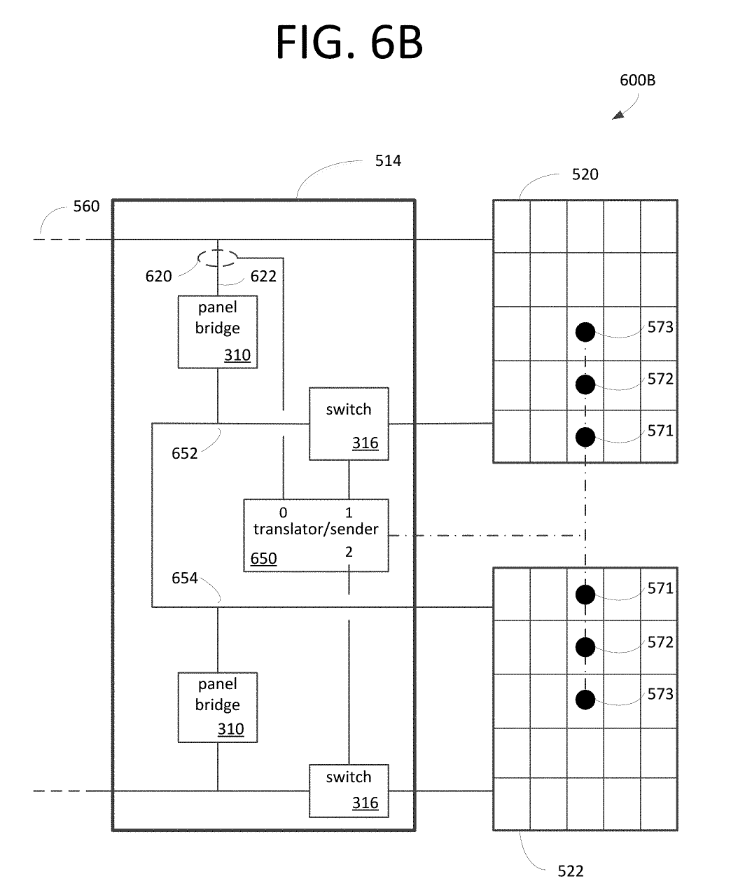

FIGS. 5-6A-B show other embodiments of solar panel communications systems 500, 600A-B.

FIG. 5 shows another embodiment of a solar panel array connected to a converter. In the figure a converter 110 is connected to four or more solar panels 520, 522, 524, 526.

A signal bridge with controller 112 is connected between the converter 110 and panel bridges with controllers 514, 516 and wiring 560 connects the signal and panel bridges. The panel bridge with controller 514 interconnects the signal bridge with controller 112 and solar panels 520, 522. The panel bridge with controller 516 interconnects the signal bridge with controller 112 and solar panels 524, 526. As described, i) the converter to signal bridge interconnect, ii) the signal bridge to panel bridge interconnect and iii) the solar panel to panel bridge interconnect do not preclude intervening devices.

Signals from the signal bridge with controller 112 reach the panel bridge with controller via the wiring 560. Typical of a panel bridge with controller 514, 516 is the panel bridge with controller 514 of FIG. 6A.

As seen in the FIG. 6A, a single translator/sender 650 interconnects with two switches 316 that are for removing panels 520, 522 from the circuit. Coupled with a panel bridge lead 622 is a magnetic coupler such as a toroidal transformer 620 that is for exchanging signals with terminal 0 of the translator/sender. For example a signal that opens or closes the switches 316 via the translator/sender terminal 1, 2 connections with the switches.

The first panel bridge 310 is across the outputs of the first solar panel 520 and a second panel bridge 310 is across the outputs of a second solar panel 522. In an embodiment, the switches 316 are between the panels 520, 522 and the panel bridge lead connection 652, 654.

In the first solar panel 520 circuit, the switch 316 provides a means for disconnecting/connecting the solar panel from the circuit. In the second solar panel 522 circuit, a second switch 316 provides a means for disconnecting/connecting the solar panel from the circuit.

Also typical of a panel bridge with controller 514, 516 is the panel bridge with controller 514 of FIG. 6B.

As seen in the FIG. 6B, a single translator/sender 650 interconnects with two switches 316 and with transducers for each panel. In various embodiments the translator/sender 650 includes a metrics block as shown in FIG. 3C annotated item 317. The transducers may be for temperature 571, for current 572 and for voltage 573.

The first panel bridge 310 is across the outputs of the first solar panel 520 and a second panel bridge 310 is across the outputs of a second solar panel 522. In an embodiment, the switches 316 are between the panels 520, 522 and the panel bridge lead connection 652, 654.

Coupled with a panel bridge lead 622 is a magnetic coupler such as a toroidal transformer 620 that is for exchanging signals with terminal 0 of the translator/sender. For example a signal that opens or closes the switches 316 via the translator/sender terminal 1, 2 connections with the switches. For example signals that provide the signal bridge 112 with panel management information such as temperature, current, and voltage.

In other embodiments of the panel bridge with controller, a single translator/sender may interconnect with three, four, or more switches 316 and with transducers for each panel. These embodiments utilize a similar architecture to that of FIG. 6A.

Panel bridge designs other than the panel bridge design of FIG. 3A and FIG. 6A may be used.

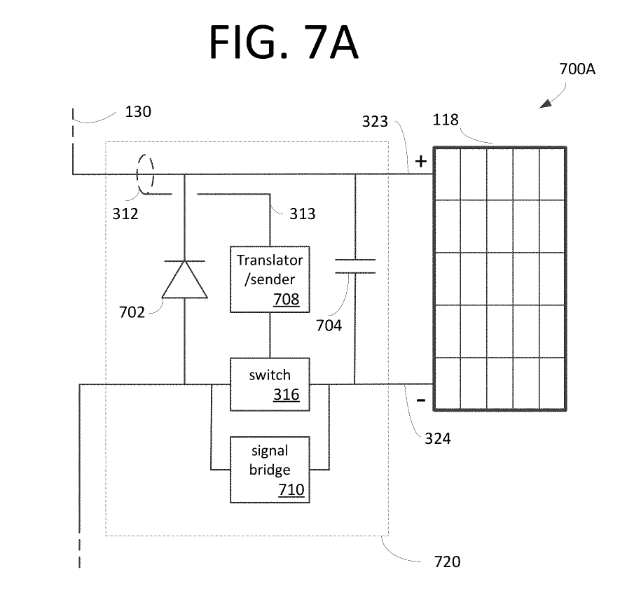

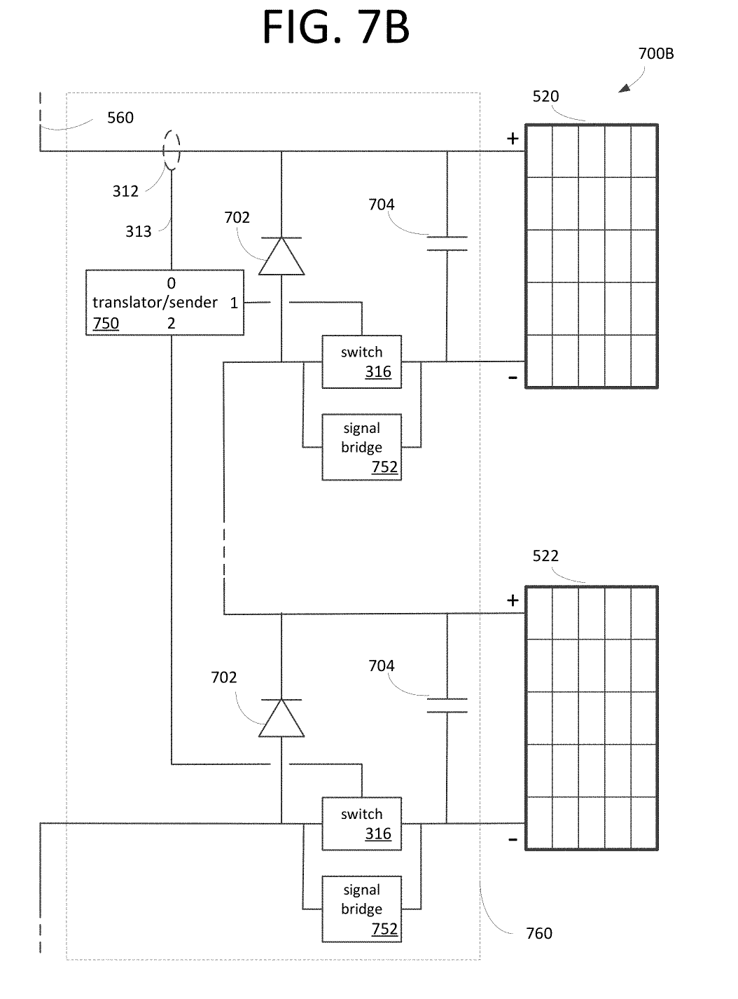

FIG. 7A shows an alternative panel bridge and controller design 700A. In the alternative panel bridge and controller design a capacitor 704 and a diode 702 are across solar panel 118 outputs 323, 324. In the negative solar panel output and between the capacitor 704 and the anode of the diode 702 is a switch 316. Across the switch is a signal bridge 710. The signal bridge is a capacitor network such as 200B, 200C, 200D.

A magnetic coupling such as a toroidal transformer 312 is for injecting currents and for sensing currents flowing in the positive solar panel output lead 323. In particular, the magnetic coupling is located adjacent to the cathode connection of the diode 702 in the wiring 130 that connects with the converter. The toroidal transformer 312 is connected 313 to a translator/sender 708 which is in turn connected to the switch 316.

Signals that originate at the signal bridge near the converter are conducted by the wiring 130 to the panel bridge, are translated and affect, for example, switch state. Signals that originate at the panel bridge near the panel are conducted by the wiring 130 to the signal bridge, are translated and provide, for example, performance of the panel.

The panel bridge and controller alternative 720 may be substituted for the panel bridge and controller 114 and 116 of FIG. 1.

FIG. 7B shows an alternative panel bridge and controller design 700B. In the alternative panel bridge and controller design two solar panels are connected together.

With the first solar panel 520, a capacitor 704 and a diode 702 are across the outputs of the panel 520. In the negative solar panel output and between the capacitor 704 and the anode of the diode 702 is a switch 316. Across the switch is a signal bridge 752. The negative solar panel output lead of the first panel is connected to the positive output lead of a second solar panel 522.

With the second solar panel 522, a capacitor 704 and a diode 702 are across the outputs of the panel 522. In the negative solar panel output and between the capacitor 704 and the anode of the diode 702 is a switch 316. Across the switch is a signal bridge 752. The signal bridge is a capacitor network such as 200B, 200C, 200D.

A magnetic coupling such as a toroidal transformer 312 is for injecting currents and for sensing currents flowing in the positive solar panel output lead of the first panel. In particular, the magnetic coupling is located adjacent to the cathode connection of the diode 702 in the wiring 560 that connects with the converter.

As seen, the toroidal transformer 312 is connected 313 to the translator/sender 750 at terminal 0. Terminal 1 of the translator/sender connects to the switch 316 at the first panel 520 and terminal 2 of the translator/sender connects to the switch 316 at the second panel 522.

Signals that originate at the signal bridge near the converter are conducted by the wiring 560 to the panel bridge, are translated and affect, for example, switch state in two switches. Signals that originate at the panel bridges near the panels are conducted by the wiring 560 to the signal bridge, are translated and provide, for example, performance of the panels.

The panel bridge and controller alternative 760 may be substituted for the panel bridge and controller 514 and 516 of FIG. 5.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A solar panel array communications system comprising:
a plurality of panels connected in a series circuit, the panels for supplying a converter;
signal bridges including a capacitor network;
panel bridges including a signal bridge in parallel with a diode;
a signal bridge across the converter inputs and a signal toroidal transformer for injecting a current into the signal bridge; and,
one of the panels with a panel bridge across the panel outputs, a panel toroidal transformer for sensing current passing through the panel bridge, and a switch activated by the panel toroidal transformer;
wherein the switch is for removing the panel from the circuit and a change in current injected by the signal toroidal transformer is sensed by the panel toroidal transformer to change the state of the switch.

2. The solar panel array communications system of claim 1 wherein the capacitor network includes a circuit with a capacitor in series with a resistor and a resistor in parallel with the circuit.

3. The solar panel array communications system of claim 1 wherein the capacitor network includes a circuit with a capacitor in series with an inductor and a resistor in parallel with the circuit.

4. The solar panel array communications system of claim 1 wherein the signal bridge includes a capacitor in parallel with a resistor.

5. The solar panel array communications system of claim 4 further comprising:
a temperature transducer for measuring a temperature associated with one of the solar panels;
the panel toroidal transformer for injecting a current in the panel bridge lead that is related to the measured temperature; and,
the signal toroidal transformer for sensing the injected current.

6. The solar panel array communications system of claim 4 further comprising:
a current transducer for measuring a current associated with one of the solar panels;
the panel toroidal transformer for injecting a current in the panel bridge lead that is related to the measured current; and,
the signal toroidal transformer for sensing the injected current.

7. The solar panel array communications system of claim 4 further comprising:
a voltage transducer for measuring a voltage associated with one of the solar panels;
the panel toroidal transformer for injecting a current in the panel bridge lead that is related to the measured voltage; and,
the signal toroidal transformer for sensing the injected current.

8. A solar panel array communications system comprising:
a plurality of panels connected in a series circuit, the panels for supplying a converter;
signal bridges including a capacitor network;
panel bridges including a diode in parallel with a signal bridge;
for a first pair of panels, panel bridges across panel outputs and a first panel toroidal transformer for sensing current in a panel bridge lead;
for each of the first pair of panels, switches for removing the panels from the circuit;
for a second pair of panels, panel bridges across panel outputs and a second panel toroidal transformer for sensing current in a panel bridge lead;
for each of the second pair of panels, switches for removing the panels from the circuit; and,
a signal bridge across the converter inputs and a signal toroidal transformer for injecting current into a signal bridge lead;
wherein the state of the switches is changed when the current injected at the signal toroidal transformer is changed.

9. The solar panel array communications system of claim 8 wherein the capacitor network includes a circuit with a capacitor in series with a resistor and a resistor in parallel with the circuit.

10. The solar panel array communications system of claim 8 wherein the capacitor network bridge includes a circuit with a capacitor in series with an inductor and a resistor in parallel with the circuit.

11. The solar panel array communications system of claim 8 wherein the capacitor network includes a capacitor in parallel with a resistor.

12. The solar panel array communications system of claim 11 further comprising:
a temperature transducer for measuring a temperature associated with one of the solar panels;
one of the panel toroidal transformers for injecting a current in a panel bridge lead that is related to the measured temperature; and,
the signal toroidal transformer for sensing the injected current.

13. The solar panel array communications system of claim 11 further comprising:
a current transducer for measuring a current associated with one of the solar panels;
one of the panel toroidal transformers for injecting a current in a panel bridge lead that is related to the measured current; and,
the signal toroidal transformer for sensing the injected current.

14. The solar panel array communications system of claim 11 further comprising:
a voltage transducer for measuring a voltage associated with one of the solar panels;
one of the panel toroidal transformers for injecting a current in a panel bridge lead that is related to the measured voltage; and,
the signal toroidal transformer for sensing the injected current.

15. A solar panel array communications system comprising:
a plurality of panels connected in a series circuit, the panels for supplying a converter;
signal bridges including a capacitor network;
a signal bridge across the converter inputs and a signal toroidal transformer for injecting a current into the signal bridge;
one of the panels with a capacitor and a diode across the outputs, the capacitor being closest to the panel;
between the diode anode connection and the capacitor connection to the negative panel output a switch and across the switch a signal bridge;
a panel toroidal transformer for sensing current in the positive panel output, the transformer not between the diode cathode connection and the panel; and,
the switch activated by the panel toroidal transformer;
wherein the switch is for removing the panel from the circuit when a change in current injected by the signal toroidal transformer is sensed by the panel toroidal transformer and changes the state of the switch.

16. A solar panel array communications system comprising:
a plurality of panels connected in a series circuit, the panels for supplying a converter;
signal bridges including a capacitor network;
a signal bridge across the converter inputs and a signal toroidal transformer for injecting a current into the signal bridge;
for a first panel
a capacitor and a diode across the outputs, the capacitor being closest to the panel,
between the diode anode connection and the capacitor connection to the negative panel output a switch and across the switch a signal bridge,
a panel toroidal transformer for sensing current in the positive panel output, the transformer not between the diode cathode connection and the panel;
for a second panel
a capacitor and a diode across the outputs, the capacitor being closest to the panel,
between the diode anode connection and the capacitor connection to the negative panel output a switch and across the switch a signal bridge; and,
the switches activated by the panel toroidal transformer;
wherein the switches are for removing the panels from the circuit when a change in current injected by the signal toroidal transformer is sensed by the panel toroidal transformer and changes the state of the switches.
